(19) United States
(12) Patent Application Publication
(10) Pub. No.: US 2010/0280960 A1
(43) Pub. Date: Nov. 4, 2010

(54) APPARATUS AND METHODS FOR NEGOTIATING DISCOUNT OFFERS

(76) Inventors: Agisilaos-Georgios Ziotopoulos, Austin, TX (US); Dimosthenis Kaleas, Carlsbad, CA (US); Eric Bilange, San Diego, CA (US)

Correspondence Address: QUALCOMM INCORPORATED, 5775 MOREHOUSE DR., SAN DIEGO, CA, 92121, US

(21) Appl. No.: 12/435,124

(22) Filed: May 4, 2009

(51) Int. Cl. G06Q 30/00; G06Q 20/00

(52) U.S. Cl. 705/80; 705/14.1; 705/14.24; 705/14.34; 705/14.38; 705/21

(57) ABSTRACT

Apparatus, systems, and methodologies are provided that facilitate negotiating discount offers. Mobile devices are equipped to detect product identification data from a barcode or RFID tag. The product identification data can be wirelessly transmitted to a discount negotiator which calculates a discount offer for the product and sends a discount offer back to the mobile device while the customer is considering whether to purchase the product. The discount negotiator calculates the discount offers based on a set of rules which may account for one or more factors, including the expiration date of a product, the quantity being purchased, product bundling, and/or the like.

### BACKGROUND

The described aspects relate to discount offers, and more particularly, to apparatus and methods for automatically negotiating discount offers.

Discounts are generally used to entice customers to purchase particular items or shop at a particular store. Retailers use a variety of methods to offer discounts to customers. Examples of such discount offers may include personal negotiation, television advertisements, radio advertisements, print advertisements, signs, coupons, direct mail, in-store announcements, etc. Coupons may be physically delivered to customers through printed advertisements in periodicals, in the store, placed on shelves near the products, through direct mail, etc.

When a retailer advertises discounts using printed media, the retailer plans the sale and then commit to it for a certain period of time. For example, if a coupon is printed in a newspaper, the retailer includes an expiration date on the coupon. Generally, the coupon will remain valid for a period of time. This requires the retailer to continue to offer the discount even if it is no longer beneficial. Furthermore, even if a set of coupons is disseminated within a store, customers are allowed to take the coupons when they leave and use them at a later time.

In addition, each of the above-mentioned methods of offering discounts may require a certain amount of lead time between the decision to offer the discount and the completion of a sale prompted by the promotion. A retailer can decrease the lead time necessary to provide coupons to customers and the duration of the sale by placing individual coupons on the shelves with the applicable product. When the retailer physically puts the coupons on the shelves in all of its locations, it allows the customer to see the discount while looking at the product. The retailer can then remove the coupons when it no longer wishes to offer a particular discount. Similarly, retailers can place a display next to each product for which it wants to offer a discount and remove the display detailing the discount offer at a time of its choosing.

Retailers may also employ salespeople to negotiate with customers. By using salespeople, the discount offered on a product may be customized to a particular situation. This, however, requires paying the salespeople commissions and/or salaries. As a result, this practice is employed when the value of the items being sold is high enough to justify those expenses.

Additionally, current methods for redemption of coupons may be problematic. For example, with paper coupons, the coupon must be physically handled, requiring a person at the point of sale to either manually enter the coupon information, or to manually scan a bar code. Further, such paper coupons require storage for back room accounting purposes. All of these redemption requirements increase the burden at the point of sale.

Given the foregoing, what are needed are improved apparatus and systems for making discount offers and redeeming such offers.

### SUMMARY

The following presents a simplified summary of one or more aspects in order to provide a basic understanding of such aspects. This summary is not an extensive overview of all contemplated aspects, and is intended to neither identify key or critical elements of all aspects, nor delineate the scope of any or all aspects. Its sole purpose is to present some concepts of one or more aspects in a simplified form as a prelude to the more detailed description that is presented later.

In accordance with one or more aspects, a method for negotiating discounts over a wireless network is provided. The method can comprise detecting product identification data for a product using a mobile device and transmitting the product identification data to a discount negotiator application. The method can also include receiving, at the mobile device, a discount offer for the product from the discount negotiator application.

Another aspect relates to a processor configured to negotiate discounts over a wireless network. The processor is configured to detect product identification data for a product using a mobile device. The processor is further configured to transmit the product identification data to a discount negotiator application. The processor is further configured to receive, at the mobile device, a discount offer for the product from the discount negotiator application.

Yet another aspect relates to a computer program product, which can have a computer-readable medium including at least one instruction for causing at least one computer to detect product identification data for a product using a mobile device. The computer-readable medium can also comprise at least one instruction for causing the computer to transmit the product identification data to a discount negotiator application. Moreover, the computer-readable medium can comprise at least one instruction for causing the computer to receive, at the mobile device, a discount offer the product from the discount negotiator application.

Still another aspect relates to an apparatus. The apparatus can comprise means for detecting product identification data for a product using a mobile device. The apparatus can additionally include means for transmitting the product identification data to a discount negotiator application and means for receiving, at the mobile device, a discount offer for the product from the discount negotiator application.

Another aspect relates to an apparatus. The apparatus comprises a product identification data detector that detects product identification data for a product using a mobile device and a transmitter that transmits the product identification data to a discount negotiator application. The apparatus further comprises a receiver that receives, at the mobile device, a discount offer for the product from the discount negotiator application.

According to a further aspect, a method for automatically negotiating discounts over a wireless network is provided. The method can comprise receiving product identification data for a product from a mobile device and retrieving characteristic information about the product from a retailer inventory database. The method can further comprise calculating a discount offer based on predetermined rules and information contained in the retailer inventory database. The method can also include transmitting the discount offer to the mobile device.

Another aspect relates to a processor configured to automatically negotiate discounts over a wireless network. The processor is configured to receive product identification data for a product from a mobile device. The processor is further configured to query a retailer inventory database and calculate a discount offer. The processor is also configured to transmit the discount offer to the mobile device.

Another aspect relates to a computer program product, which can have a computer-readable medium including at least one instruction for causing at least one computer to receive product identification data for a product from a mobile device. The computer-readable medium can also comprise at least one instruction cause the computer to retrieve characteristic information about the product from a retailer inventory database. Moreover, the computer-readable medium can comprise at least one instruction to cause the computer to calculate a discount offer based on predetermined rules and transmit the discount offer to the mobile device.

Yet another aspect relates to an apparatus. The apparatus can comprise means for receiving product identification data for a product from a mobile device. The apparatus can also comprise means for querying a retailer inventory database. The apparatus can further comprise means for calculating a discount offer and means for transmitting the discount offer to the mobile device.

Still another aspect relates to an apparatus. The apparatus comprises a receiver that receives product identification data for a product from a mobile device. The apparatus further comprises a retailer inventory database query application that retrieves characteristic information about the product from the retailer inventory database. The apparatus can also comprise a discount offer negotiation application that automatically calculates a discount offer for the product and a transmitter that sends the discount offer to the mobile device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of an automated discount negotiation system in accordance with one aspect set forth herein.

FIG. 2 is an illustration of an example mobile device for employment within an automated discount negotiation system, according to another aspect.

FIG. 3 is an illustration of an example automated discount payment negotiator for employment within an automated discount negotiation system, according to yet another aspect.

FIG. 4 is an illustration of an example point of sale terminal for employment within an automated discount negotiation system, according to one aspect.

FIG. 5 is an illustration of an example computer device for employment with a mobile device, an automated discount negotiator, and/or a point of sale terminal, according to one aspect.

FIG. 6 is an illustration of an example methodology that facilitates negotiating discounts from a mobile device, according to one aspect.

FIG. 7 is an illustration of an example methodology that facilitates negotiating discounts on behalf of a retailer, according to one aspect.

FIG. 8 is an illustration of an example system that negotiates discounts from a mobile device, according to one aspect.

FIG. 9 is an illustration of an example system that automatically negotiates discounts on behalf of a retailer, according to one aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

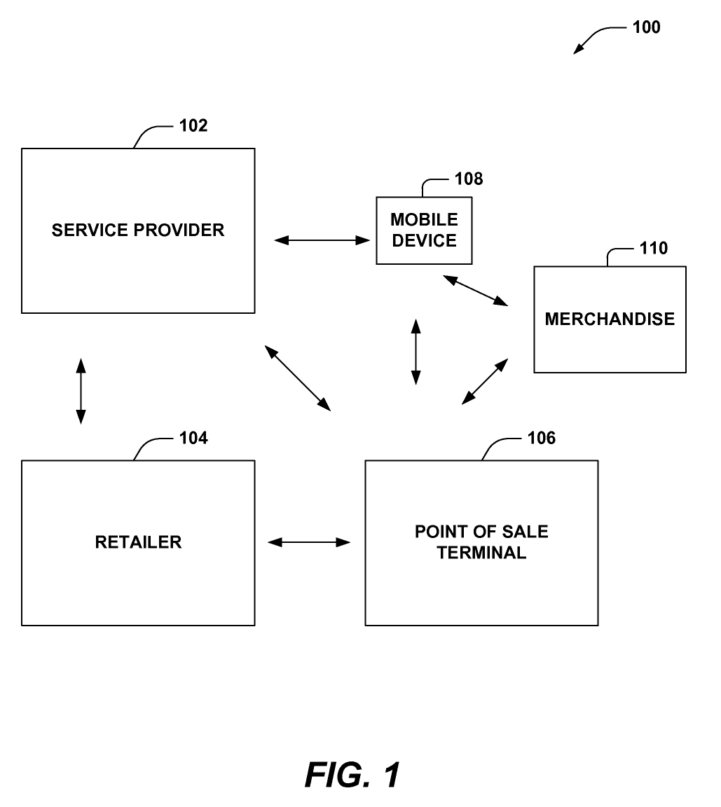

Referring now to FIG. 1, an automated discount negotiation system 100 is illustrated in accordance with one or more aspects presented herein. System 100 includes a service provider 102 that can automatically negotiate discounts with a customer on behalf of a retailer 104 while the customer is shopping. System 100 can also include one or more point of sale terminals 106 where the discount offers are applied to a purchase.

According to one aspect, a discount offer is an electronic coupon that a customer requests and receives using a mobile device 108 while shopping for merchandise 110. System 100 would employ a set of rules to create discount offers. The rules can account for a variety of factors. In one example, discount offers can be based on the expiration date of a perishable product such as milk. As the expiration date of a product approaches, the rules may specify that service provider 102 increases the value of discount offers to entice customers to purchase the product. In another example, the quantity being purchased is a factor in determining the discount offer. If a customer is willing to purchase more than one unit of a product, a bulk discount may be offered. In another example, a customer may be enticed to purchase several different products together. For example, a discount can be offered on pasta sauce when the customer is going to purchase pasta. Other possible factors the rules may be based upon may include the level of inventory of a particular product, the period of time until a new shipment will arrive, manufacturer incentives, profitability, and others.

According to one aspect, retailer 104 specifies the set of rules upon which service provider 102 calculates discount offers. In an example, retailer 104 can choose each specific rule that it wants service provider 102 to apply. In another example, retailer 104 can choose to use a stock set of rules developed by service provider 102 or retailer 104.

In one aspect, retailer 104 maintains a retailer inventory database that contains up-to-date information on the inventory of merchandise 110. As merchandise 110 is delivered, it is entered into the retailer inventory database. When a customer purchases an item at point of sale terminal 106, the retailer inventory database is updated to reflect the change. Furthermore, retailer 104 may include information about expected changes in inventory in the retailer inventory database. For example, retailer 104 may store a schedule of upcoming shipments in the retailer inventory database. Service provider 102 uses the information in the retailer inventory database to calculate discount offers based on the set of rules currently being implemented. For example, a rule may offer a greater discount on a product with an upcoming (replenishment) shipment in order to reduce the retailer's overhead cost associated with storing a large inventory of such product.

According to one aspect, point of sale terminal 106 can receive the discount offers in several ways. In one example, mobile device 108 transmits the discount offers to point of sale terminal 106. In another example, service provider 102 may monitor the product identification information of all merchandise 110 that is detected at point of sale terminal 106. Service provider 102 may then send the relevant discount offers to point of sale terminal 106 when point of sale terminal 106 receives product identification data associated with a product on which service provider 102 has made a discount offer. In another example, point of sale terminal 106 may request the discount offers for a particular customer. The customer's identification may be received from mobile device 108, a customer loyalty card, a credit card, or any suitable means of identifying a specific customer.

In one aspect, when the discount offers are received from mobile device 108, point of sale terminal 106 may verify the authenticity of the discount offers by verifying an authentication mechanism, such as a digital signature, included with the discount offer when received by mobile phone 108, by requesting verification from service provider 102, or through any other suitable means for electronically verifying authenticity. In another aspect, point of sale terminal 106 can also verify that the products on which the discount offers were made are being purchased by comparing the product identification data in the discount offer to the product identification data of the products the customer is purchasing. In one example, when a customer receives a discount offer for milk with an expiration date in two days, point of sale terminal 106 can verify the milk being purchased is the same milk that the discount offer was made on in terms of product identification data, expiration date, brand, container size, type (e.g., whole, skim, etc.), and the like.

Furthermore, when a customer tries to use a discount offer for a bulk purchase, such as ten units of a product, point of sale terminal 106 can verify that the customer actually has ten units before applying the discount. If, for example, there are only nine units, point of sale terminal 106 may alert the customer to the oversight and allow the customer to correct it, alter the discount offer, or refuse to apply the discount offer.

In one aspect, point of sale terminal 106 may apply the discount offers at the time of sale or as a credit. In one example, when point of sale terminal 106 applies the discount offer(s) at the time of sale, the total cost of the purchase is reduced by the value of the validated discount offer(s). In another example, when point of sale terminal 106 applies the discount offers as a credit, the customer pays full price and receives the value of the discount offers at a later time. The value of the discount offers may be applied to the customer's credit card bill so that the full price is paid at the time of purchase and a credit is applied before the customer pays their credit card bill. Alternatively, the credit may be applied to the customer's loyalty card and applied to a future purchase.

In one example, a customer enters the premises of retailer 104, which may be a supermarket, holding mobile device 108. Individual items of merchandise 110 may be tagged with RFID tags or barcodes so that they can be recognized. As the customer takes items of merchandise 110 from the shelves and puts them into a shopping cart, an application running on mobile device 108 detects the items and contacts service provider 102 to get the prices of the goods. The customer, through the application running on mobile device 108, can request a discount offer with proposed parameters (e.g., buying more bottles of milk for a family that usually consumes a lot of milk, etc.). The application running on mobile device 108 may be downloaded from service provider 102 or be activated when the customer enters the premises of a retailer 104. In one aspect, for example, service provider 102 may determine that the customer has entered the premises of retailer 104 using location sensors (e.g., mobile device 108 with GPS capability combined with geofencing markers identifying the premises, etc.).

Service provider 102 may issue discount offers to mobile device 108 that indicate, for example, “If the holder of this coupon purchases 10 bottles of milk, then charge the customer $0.90/bottle instead of the regular price of $1/bottle.” The discount offer may be, for example, a digitally signed string. At checkout time, the customer may present the discount offers by transmitting them from mobile device 108 to a receiver in point of sale terminal 106. The cashier may then verify, for example, that the quantity of the goods being purchased matches the negotiated quantity. At that point the cashier charges the customer the reduced price which the customer negotiated.

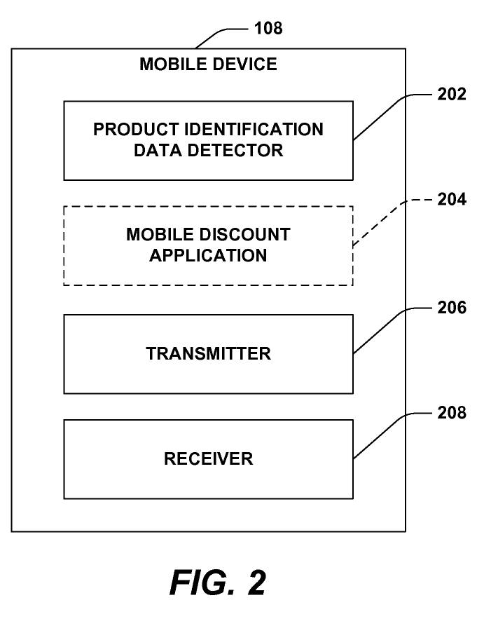

Turning to FIG. 2, a mobile device 108 for use within automated discount negotiation system 100 is illustrated. Mobile device 108 can be, for example, a cellular phone, a smart phone, a laptop, a handheld communication device, a handheld computing device, a PDA, and/or any other suitable device for communicating over wireless networks. Mobile device 108 includes product identification data detector 202, an optional (as indicated by dashed lines) mobile discount application 204, transmitter 206, and receiver 208. In one example, product identification data detector 202 may be an RFID scanner or a barcode reader. This allows a customer to scan an item with mobile device 108 and retrieve its product identification information.

Mobile discount application 204 optionally is resident on mobile device 108, or alternatively may be remotely available to mobile device 108, such as via service provider 102 or any other computer device in communication with mobile device 108. In any case, mobile discount application 204 may allow or trigger product identification data detector 202 to scan an item, accept proposed parameters for a discount offer from the customer, display a discount offer, and/or allow a customer to expressly accept a discount offer. In another aspect, mobile discount application 204 may also allow a customer to indicate a set of rules to execute automatically. A set of rules may be one or more actions such as making a discount request as soon as product identification data for an item is detected, e.g. if the expiration date is within a set number of days from today, and may wait for authorization from the customer before making the discount request, always making a discount request for a specified purchase quantity for specified merchandise or for combinations of merchandise, e.g. based on historical buying patterns of the customer, and the like.

In one aspect, mobile discount application 204 executes when mobile device 108 is determined to be within the premises of retailer 104. In one example, a user executes mobile discount application 204 manually. In another example, mobile discount application 204 executes automatically when mobile device 108 enters the premises of retailer 104. The automatic execution of mobile discount application 204 may be triggered when GPS tracking on mobile device 108 indicates that mobile device 108 has entered the premises of retailer 104. For example, the automatic execution of mobile discount application 204 may also be triggered using geofencing technology, or based on receipt of a beacon from within the location of the retailer, or another suitable means of determining that mobile device 108 has entered the premises of retailer 104.

In another aspect, mobile discount application 204 may download a set of rules when it is executed. In one example, when a customer enters the premises of retailer 104, the set of rules for calculating discount offers is downloaded to mobile device 108. The downloaded set of rules is then used by a discount offer negotiation application that executes on mobile device 108 to calculate discount offers.

Transmitter 206 and receiver 208 communicate with service provider 102. Transmitter 206 and receiver 208 may communicate using a cellular network, WiFi, EVDO, broadband wireless networks, and/or other suitable means for communicating over wireless networks.

According to one aspect, transmitter 206 sends product identification data to service provider 102 and receiver 208 receives one or more discount offers in response. In another aspect, transmitter 206 may also transmit requests for discount offers which take into account specific factors. For example, a customer may request a discount for a specific quantity of a product or a particular combination of products. For example, a customer may request a bulk discount on five units of a product. In yet another aspect, transmitter 206 may transmit an express indication of acceptance from the customer.

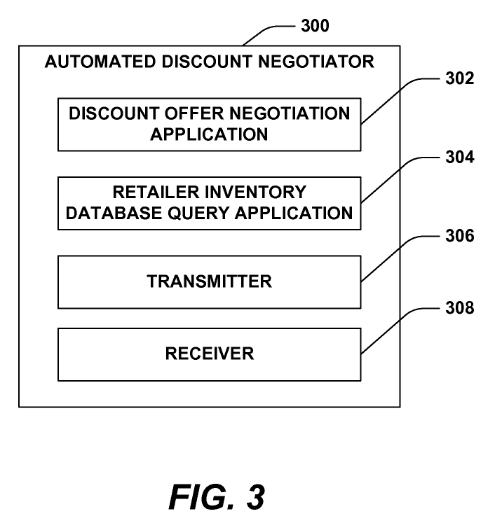

Now referring to FIG. 3, an automated discount negotiator 300 is illustrated, according to one aspect. The automated discount negotiator 300 is operated by service provider 102. In one aspect, automated discount negotiator 300 includes a discount offer negotiation application 302, a retailer inventory database query application 304, a transmitter 306, and a receiver 308. Discount offer negotiation application 302 calculates discount offers according to selected set of rules supplied by service provider 102 or retailer 104, as described above. In one example, transmitter 306 and receiver 308 communicate with mobile device 108 and service provider 102 using a cellular network, WiFi, EVDO, broadband wireless networks, or means suitable for communicating over a wireless network. In addition, transmitter 306 and receiver 308 may communicate with point of sale terminal 106 in the same manner, or using a landline or network connection.

In one aspect, when automated discount negotiator 300 receives product identification data, retailer inventory database query application 304 retrieves product characteristic information about the product from the retailer inventory database. The information retrieved may include characteristic information about the product specified by the product identification data that is received as well as information about inventory levels and scheduled shipment dates. In one example, automated discount negotiator 300 uses the retrieved information to offer discounts that may vary depending on inventory level, purchase quantity, associated purchase products, expiration date and upcoming delivery schedules.

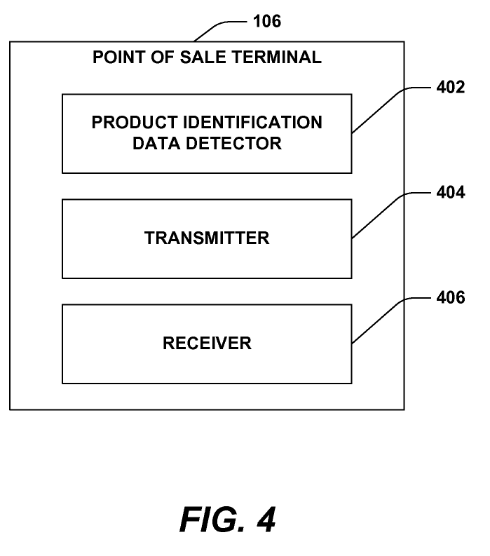

Turning to FIG. 4, a point of sale terminal 106 is illustrated, according to one aspect. The point of sale terminal 106 can include product identification data detector 402, transmitter 404, and receiver 406. In one example, product identification data detector 402 may be an RFID scanner or a barcode reader. In one aspect, product identification data detector 402 reads the product identification data as part of the standard checkout process. In one example, this takes place regardless of whether there is a discount offer for a particular product. Transmitter 404 and receiver 406 communicate with service provider 102, retailer 104, and mobile device 108 as described above.

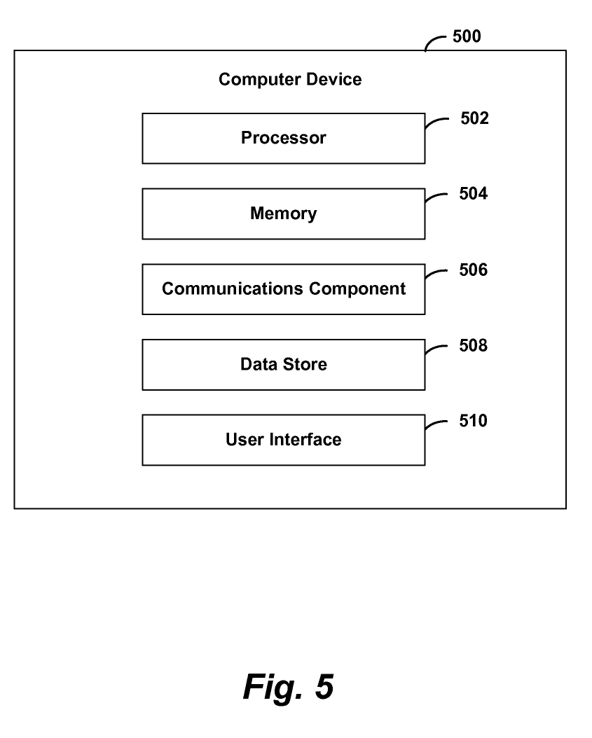

Referring to FIG. 5, in one aspect, any of mobile device 108 (FIG. 2), automated discount negotiator 300 (FIG. 3), and/or point of sale terminal 106 (FIG. 4) may be represented by computer device 500. Computer device 500 includes a processor 502 for carrying out processing functions associated with one or more of components and functions described herein. Processor 502 can include a single or multiple set of processors or multi-core processors. Moreover, processor 502 can be implemented as an integrated processing system and/or a distributed processing system.

Computer device 500 further includes a memory 504, such as for storing local versions of applications being executed by processor 502. Memory 504 can include any type of memory usable by a computer, such as random access memory (RAM), read only memory (ROM), tapes, magnetic discs, optical discs, volatile memory, non-volatile memory, and any combination thereof.

Further, computer device 500 includes a communications component 506 that provides for establishing and maintaining communications with one or more parties utilizing hardware, software, and services as described herein. Communications component 508 may carry communications between components on computer device 500, as well as between computer device 500 and external devices, such as devices located across a communications network and/or devices serially or locally connected to computer device 500. For example, communications component 500 may include one or more buses, and may further include transmit chain components and receive chain components associated with a transmitter and receiver, respectively, operable for interfacing with external devices.

Additionally, computer device 500 may further include a data store 508, which can be any suitable combination of hardware and/or software, that provides for mass storage of information, databases, and programs employed in connection with aspects described herein. For example, data store 508 may be a data repository for applications not currently being executed by processor 502.

Computer device 500 may additionally include a user interface component 510 operable to receive inputs from a user of computer device 500, and further operable to generate outputs for presentation to the user. User interface component 510 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 510 may include one or more output devices, including but not limited to a display, a speaker, a haptic feedback mechanism, a printer, any other mechanism capable of presenting an output to a user, or any combination thereof.

Additionally, in one or more aspects, the components discussed above with reference to FIGS. 2, 3, and 4, such as product identification data detector 202, mobile discount application 204, discount offer negotiation application 302, retailer inventory database query application 304, and/or product identification data detector 402, may be included in the above-described computer device 500, which may be a client-side or network side device.

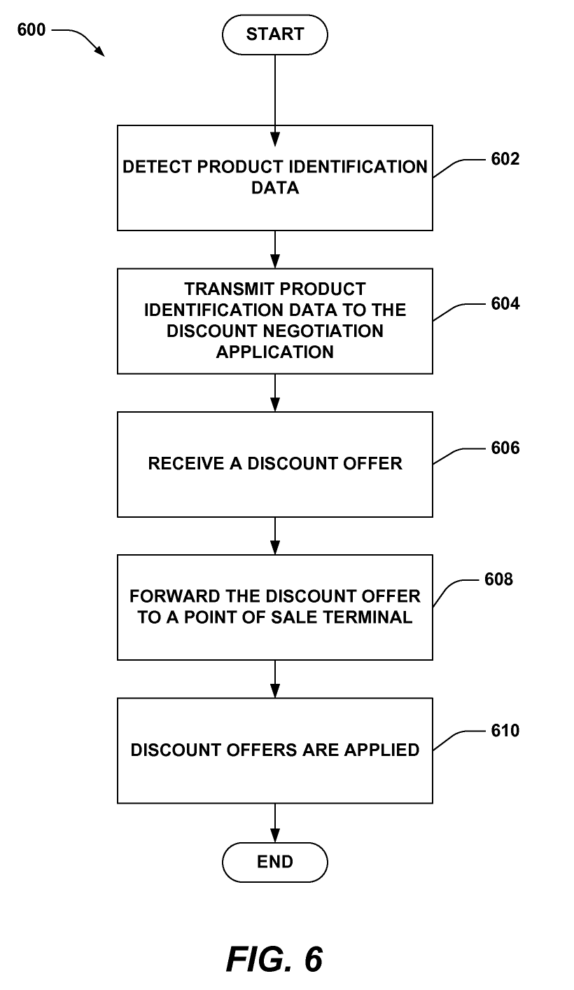

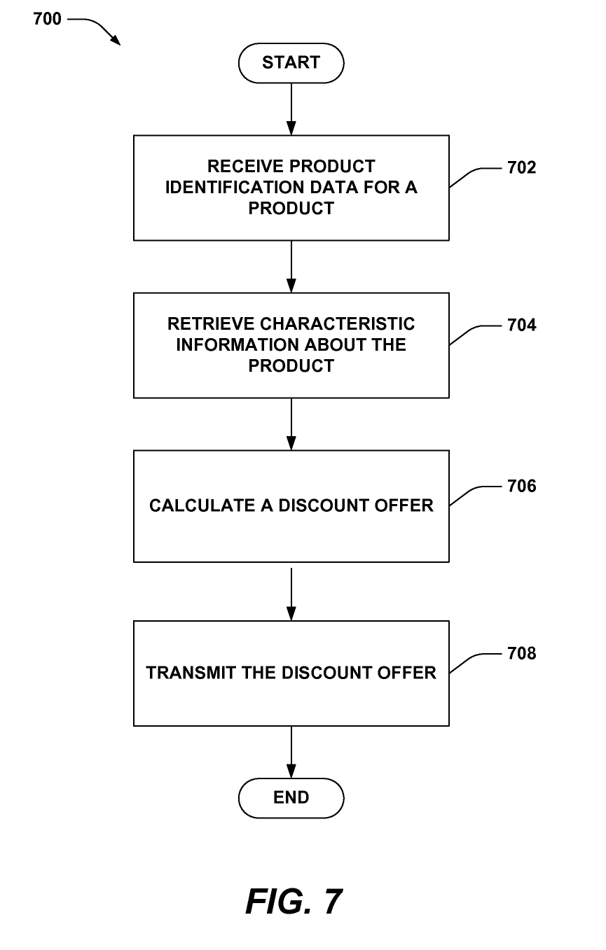

Referring to FIGS. 6-7, methodologies relating to automatically negotiating discount offers are illustrated. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Now referring to FIG. 6, a methodology 600 that facilitates receiving discount offers is displayed, according to one aspect. At 602, a customer selects a product and uses a mobile device to detect the product identification data. In one aspect, the customer may enter parameters such as a proposed quantity or proposed product bundle into the mobile device. At 604, once the mobile device has product identification data and any parameters that will be included in the request for a discount offer, transmits the product identification data (and parameters) to discount negotiation application 302. At 606, the customer receives a response to the request, including a refusal of the request or a discount offer (e.g. a reduction off of a labeled price of a product, a credit granted to the customer having a value corresponding to the discount offer, etc.). In one example, the customer repeats this process for any product being purchased on which a discount may be desired. In one aspect, when the customer purchases the products on which discount offers were made, at 608, the method further includes forwarding the discount offers to a point of sale terminal so that the discount offer(s) are applied to the purchase price. In another aspect, at 610, when the customer purchases the products on which discount offers were made, the discount offers are applied as a credit to the customer, such as by reducing the current purchase price or by applying a credit to an account, such as a bank or credit card account and/or a customer loyalty account.

Turning to FIG. 7, a methodology 700 that facilitates automatically negotiating discount offers with a customer is displayed, according to one aspect. At 702, product identification data is received from a customer. At 704, characteristic information about the identified product is retrieved from a retailer inventory database maintained by product retailer 104. According to one example, the characteristic information can include the expiration date of the product, the inventory level of the product, the scheduled delivery date for a shipment, manufacturer sales incentives, and/or the like. At 706, a discount offer is calculated. In one example, the discount offer is calculated based on the set of rules that were specified or selected by retailer 104. These rules may apply discounts based on a variety of factors including the period of time until a product's expiration date, product bundling, bulk purchases, overstocked products, and/or the like. At 708, the discount offer is transmitted to the customer. In one example, the discount offer is also transmitted to a point of sale for verification at checkout. In another example, the discount offer is transmitted with a digital signature that can be verified at checkout.

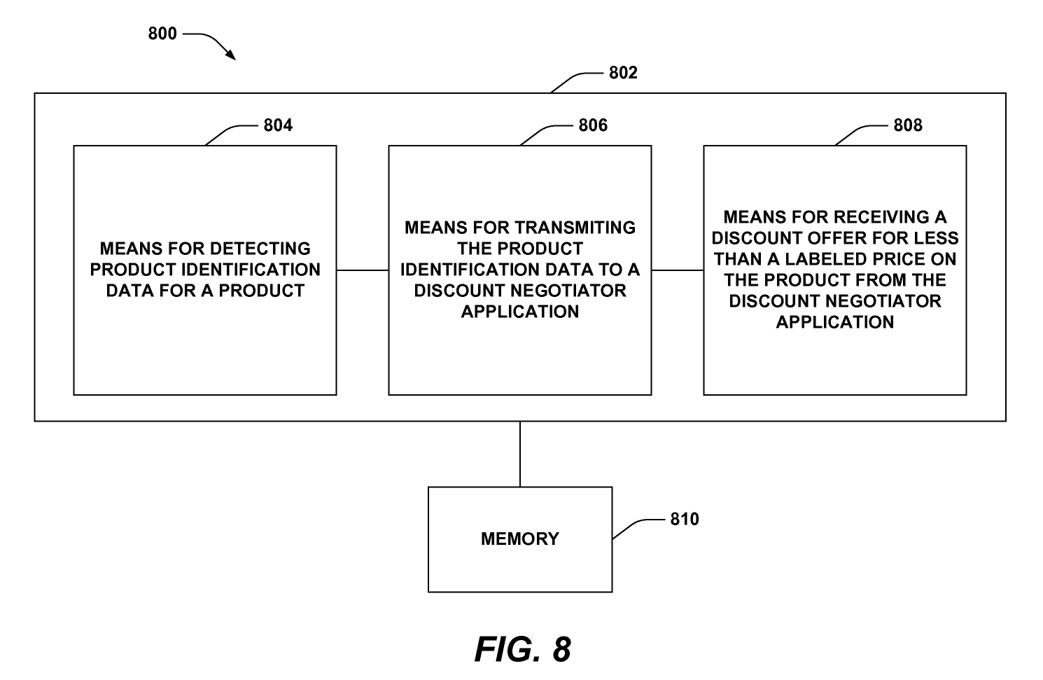

With reference to FIG. 8, illustrated is a system 800 that facilitates receiving discount offers, according to one aspect. For example, system 800 can reside within a mobile device. It is to be appreciated that system 800 is represented as including functional blocks, which can be functional blocks that represent functions implemented by a processor, software, or combination thereof (e.g., firmware, etc.). System 800 includes a logical grouping 802 of electrical components that can act in conjunction. For instance, logical grouping 802 can include means for detecting product identification data for a product. For example, the product identification data may be contained in a barcode or RFID tag and read using a barcode reader or an RFID scanner.

Further, logical grouping 802 can comprise means for transmitting product identification data to a discount negotiator application 806. Furthermore, logical grouping 802 can comprise means for receiving a discount offer for less than the labeled price on the product from the discount negotiator application 808. Additionally, system 800 can include a memory 810 that retains instructions for executing functions associated with electrical components 804, 806, and 808. While shown as being external to memory 810, it is to be understood that one or more of electrical components 804, 806, and 808 can exist within memory 810.

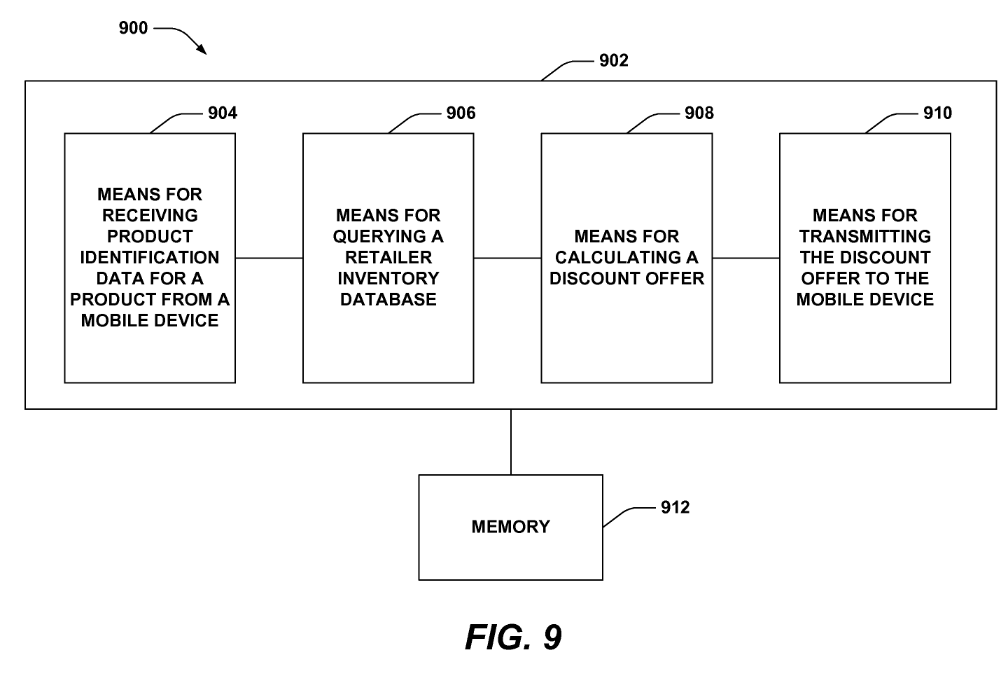

Turning to FIG. 9, illustrated is a system 900 that automatically negotiates discount offers with a customer, according to one aspect. System 900 can reside within any type of computer including a server, personal computer, laptop, etc. As depicted, system 900 includes functional blocks that can represent functions implemented by a processor, software, or combination thereof (e.g., firmware, etc.). System 900 includes a logical grouping 902 of electrical components that facilitate automatically negotiating discount offers. Logical grouping 902 can include means for receiving product identification data for a product from a mobile device. Moreover, logical grouping 902 can include means for querying a retailer inventory database 906. Thus, characteristic information about the identified product can be gathered. Furthermore, logical grouping 902 can include means for calculating a discount offer 908. In addition, logical grouping 902 can include means for transmitting the discount offer to the mobile device 910. Additionally, system 900 can include a memory 912 that retains instructions for executing functions associated with electrical components 904, 906, 908, and 910. While shown as being external to memory 912, it is to be understood that electrical components 904, 906, 908, and 910 can exist within memory 912.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc,” as used herein, includes compact disc (CD), laser disc, optical disc, digital versatile disc (DVD), floppy disk, and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects as defined by the appended claims. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise.

What is claimed is:

1. A method for negotiating discounts over a wireless network, comprising:
detecting product identification data for a product using a mobile device;
transmitting, over the wireless network, the product identification data to a discount negotiator application; and
receiving, at the mobile device, a discount offer for the product from the discount negotiator application.

2. The method of claim 1, further comprising:
transmitting at least one proposed parameter for the discount offer to the discount negotiator application.

3. The method of claim 1, further comprising:
transmitting an indication of acceptance of the discount offer to the discount negotiator application.

4. The method of claim 1, further comprising:
transmitting at least one discount offer to a point of sale terminal.

5. The method of claim 4, further comprising:
paying a price reflecting the discount offer when the product is purchased.

6. The method of claim 4, further comprising:
paying a labeled price for the product at a point of sale terminal; and
receiving a credit for a value of the discount offer.

7. The method of claim 1, wherein the discount offer is based at least in part on purchasing more than one unit of the product.

8. The method of claim 1, wherein the discount offer is based at least in part on the expiration date of the product.

9. The method of claim 1, wherein the discount offer is based at least in part on simultaneously purchasing at least one additional different product.

10. The method of claim 1, wherein the discount offer is based at least in part on reduced overhead costs.

11. The method of claim 1, wherein the product identification data is a barcode.

12. The method of claim 1, wherein the product identification data is an RFID tag.

13. At least one processor configured to negotiate discounts over a wireless network, comprising:
a first module for detecting product identification data for a product using a mobile device;
a second module for transmitting, over the wireless network, the product identification data to a discount negotiator application; and
a third module for receiving, at the mobile device, a discount offer for the product from the discount negotiator application.

14. A computer program product configured for negotiating discounts over a wireless network, comprising:
a computer-readable medium comprising:
at least one instruction for causing a computer to detect product identification data for a product using a mobile device;
at least one instruction for causing the computer to transmit the product identification data to a discount negotiator application; and
at least one instruction for causing the computer to receive, at the mobile device, a discount offer for the product from the discount negotiator application.

15. An apparatus configured for negotiating discounts over a wireless network, comprising:
means for detecting product identification data for a product using a mobile device;
means for transmitting the product identification data to a discount negotiator application; and
means for receiving, at the mobile device, a discount offer for the product from the discount negotiator application.

16. An apparatus configured for negotiating discounts over a wireless network, comprising:
a product identification data detector that detects product identification data for a product using a mobile device;
a transmitter that transmits the product identification data to a discount negotiator application; and
a receiver that receives, at the mobile device, a discount offer for the product from the discount negotiator application.

17. The apparatus of claim 16, wherein the transmitter transmits at least one proposed parameter for the discount offer.

18. The apparatus of claim 16, wherein the transmitter transmits an indication of acceptance to the discount payment offer.

19. The apparatus of claim 16, wherein the discount offer is based at least in part on purchasing more than one unit of the product.

20. The apparatus of claim 16, wherein the discount offer is based at least in part on the expiration date of the product.

21. The apparatus of claim 16, wherein the discount offer is based at least in part on simultaneously purchasing at least one additional different product.

22. The apparatus of claim 16, wherein the discount offer is based at least in part on reduced overhead costs.

23. The apparatus of claim 16, wherein the product identification data is a barcode.

24. The apparatus of claim 16, wherein the product identification data is an RFID tag.

25. The apparatus of claim 16, wherein the transmitter transmits at least one discount offer to a point of sale terminal.

26. A method for automatically negotiating discounts over a wireless network, comprising:
receiving product identification data for a product from a mobile device;
retrieving characteristic information about the product from a retailer inventory database;
calculating a discount offer based on predetermined rules and information contained in the retailer inventory database; and
transmitting, over the wireless network, the discount offer to the mobile device.

27. The method of claim 26, further comprising:
receiving at least one proposed parameter for the discount offer to the discount negotiator application from the mobile device.

28. The method of claim 26, further comprising:
receiving an indication of acceptance of the discount offer from the mobile device.

29. The method of claim 26, further comprising:
transmitting at least one discount offer to a point of sale terminal.

30. The method of claim 26, further comprising:
receiving confirmation from a point of sale terminal that the product was purchased in a quantity indicated in the discount offer.

31. The method of claim 30, further comprising:
transmitting a payment credit message to a credit card company.

32. The method of claim 26, further comprising:
calculating the discount offer based at least in part on purchasing more than one unit of the product.

33. The method of claim 26, further comprising:
calculating the discount offer based at least in part on the expiration date of the product.

34. The method of claim 26, further comprising:
calculating the discount offer based at least in part on simultaneously purchasing at least one additional different product.

35. The method of claim 26, further comprising:
calculating the discount offer based at least in part reduced overhead costs.

36. The method of claim 26, wherein the product identification data is a barcode.

37. The method of claim 26, wherein the product identification data is an RFID tag.

38. At least one processor configured to automatically negotiate discounts over a wireless network, comprising:
a first module for receiving, over the wireless network, product identification data for a product from a mobile device;
a second module for querying a retailer inventory database;
a third module for calculating a discount offer; and
a fourth module for transmitting, over the wireless network, the discount offer to the mobile device.

39. A computer program product configured to automatically negotiate discounts over a wireless network, comprising:
a computer-readable medium comprising:
at least one instruction for causing a computer to receive product identification data for a product from a mobile device;
at least one instruction for causing a computer to retrieve characteristic information about the product from a retailer inventory database
at least one instruction for causing a computer to calculate a discount offer based on predetermined rules; and
at least one instruction for causing a computer to transmit the discount offer to the mobile device.

40. An apparatus configured to automatically negotiate discounts over a wireless network, comprising:
means for receiving product identification data for a product from a mobile device;
means for querying a retailer inventory database;
means for calculating a discount offer; and
means for transmitting the discount offer to the mobile device.

41. An apparatus configured to automatically negotiate discounts over a wireless network, comprising:
a receiver that receives product identification data for a product from a mobile device;
a retailer inventory database query application that retrieves characteristic information about the product from retailer inventory database;
a discount offer negotiation application that automatically calculating a discount offer for the product; and
a transmitter that sends the discount offer to the mobile device.

42. The apparatus of claim 41, wherein the receiver receives at least one proposed parameter for the discount offer from the mobile device.

43. The apparatus of claim 41, wherein the receiver receives an indication of acceptance of the discount payment offer from the mobile device.

44. The apparatus of claim 41, wherein the discount offer negotiation application calculates the discount offer based at least in part on purchasing more than one unit of the product.

45. The apparatus of claim 41, wherein the discount offer negotiation application calculates the discount offer based at least in part on the expiration date of the product.

46. The apparatus of claim 41, wherein the discount offer negotiation application calculates the discount offer based at least in part on simultaneously purchasing at least one additional different product.

47. The apparatus of claim 41, wherein the discount offer negotiation application calculates the discount offer based at least in part on reduced overhead costs.

48. The apparatus of claim 41, wherein the product identification data is a barcode.

49. The apparatus of claim 41, wherein the product identification data is an RFID tag.

50. The apparatus of claim 41, wherein the transmitter transmits at least one discount offer to a point of sale terminal.
